(19) United States
(12) Patent Application Publication
(10) Pub. No.: US 2017/0261175 A1
(43) Pub. Date: Sep. 14, 2017

(54) Flame-Like Overlay of Light Source

(71) Applicants: Yvonne Muro, Staten Island, NY (US); John Ames, Staten Island, NY (US)

(72) Inventor: John Ames, Staten Island, NY (US)

(21) Appl. No.: 15/066,409

(22) Filed: Mar. 10, 2016

(51) Int. Cl. F21V 3/02; F21V 3/04

(52) U.S. Cl. CPC F21V 3/02; F21V 3/0436; F21W 2121/00

(57) ABSTRACT

An overlay for a light source which the shape of the overlay imitates a real flame with multiple tips. When the overlay is placed over a light, the overlay appears like a real flame.

### TECHNICAL FIELD

The present invention relates to an overlay of a light source.

### BACKGROUND ART

Light bulbs and other light sources are known in many different sizes, colors, and intensities. Different types of overlays and covers for light bulbs and light sources are also known. There are also needs and desires under certain circumstances to have the light bulbs and the light sources to appear like a real flame, whether it be a candle flame, a flame of gas, or other types of flames. For example, when an antique fixture originally designed for gas or a candle light source, such as a wrought iron chandelier, is converted to electric light source, it is desirable for the light to appear like a real flame to keep the original feel of the fixture.

Many different attempts and products exist to make a light source to appear like a real flame. There are light bulbs and other light sources shaped, colored and designed to resemble a flame. There are also different types of covers and overlays made of various materials covering the light source so the light source appears like a candle flame or a gas flame when the light source is turned on. However, the imitation flames produced by these products appear as artificial flames.

### SUMMARY OF INVENTION

The present invention is an overlay made of material that can be placed over a light bulb or a light source and is shaped like a flame with multiple tips. The overlay may also be part of the actual light source, be attached to the light bulb, or form part or all of an exterior of a light bulb. The material may be soft, hard, and/or be elastic. For example, elastomer, polymer, silicone, rubber, glass, metal, and different types of plastic or plastic based materials can be used to make the overlay.

When the overlay is placed over a light bulb or a light source, regardless of whether the light source is turned on or not, the overlay due to its shape will appear like a flame.

Further, when the light source is turned on, the overlay's material and its shape may completely block the light, be semi-transparent, or be completely transparent, resulting in no light to almost all of the light traveling through material.

When the overlay, due to the material used, can completely block the light, it can be used as a cover for a light source. The overlay can be any color but darker color is preferable when the overlay is used as a light source cover.

When the overlay is made of material which light travels through, the overlay will pass the light from the light source and appear to glow like a real flame. The overlay that does not completely block the light from the light source can also be any color but lighter color is preferable when the overlay is to pass the light from a light source.

### BRIEF DESCRIPTION OF DRAWINGS

FIG. 1 is an example of an embodiment of an overlay;

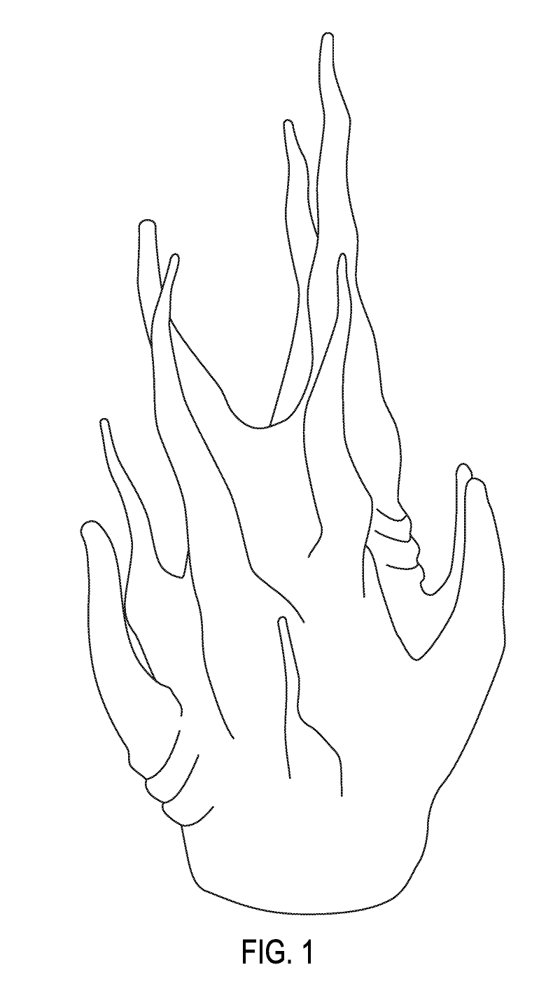

FIG. 2 is a front view thereof;

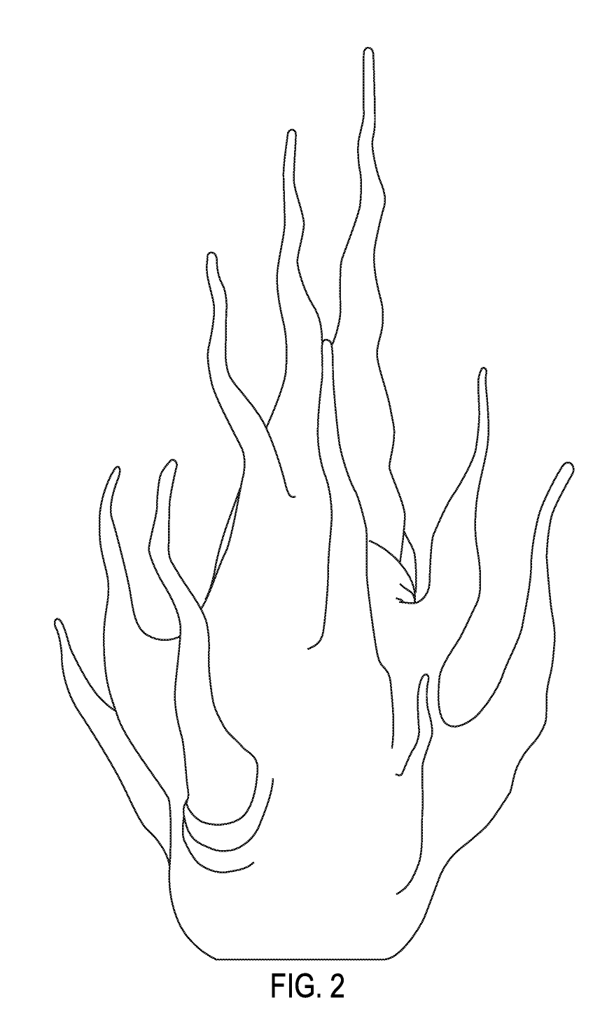

FIG. 3 is a rear view thereof;

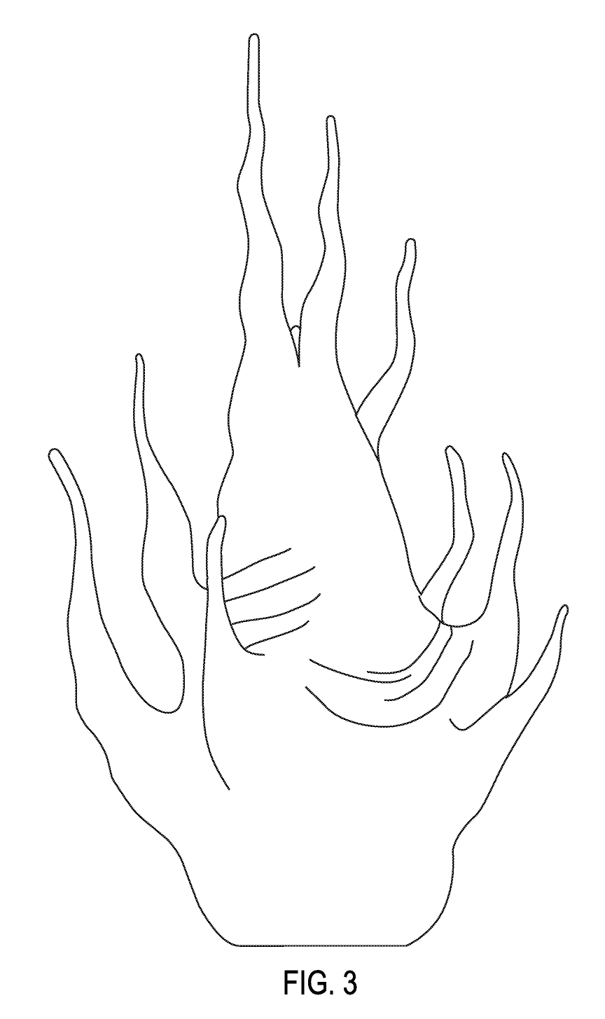

FIG. 4 is a left side view thereof;

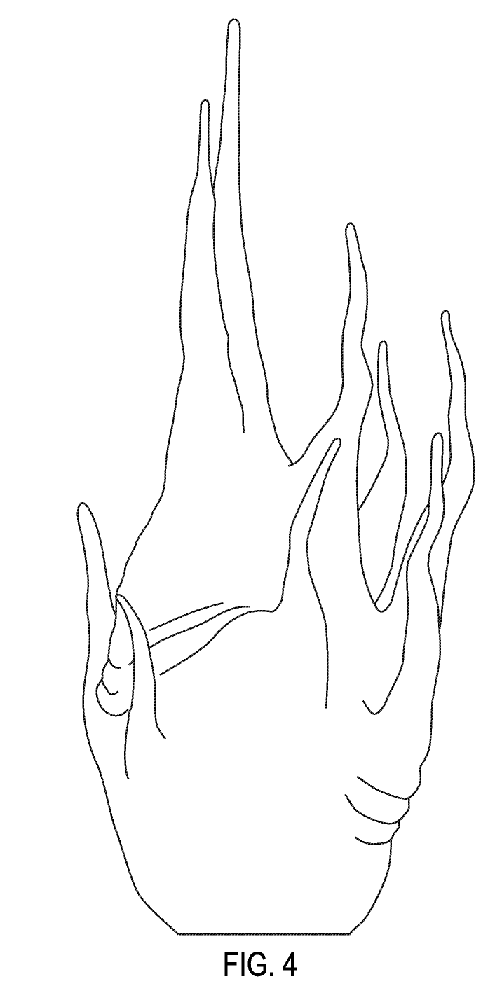

FIG. 5 is a right side view thereof;

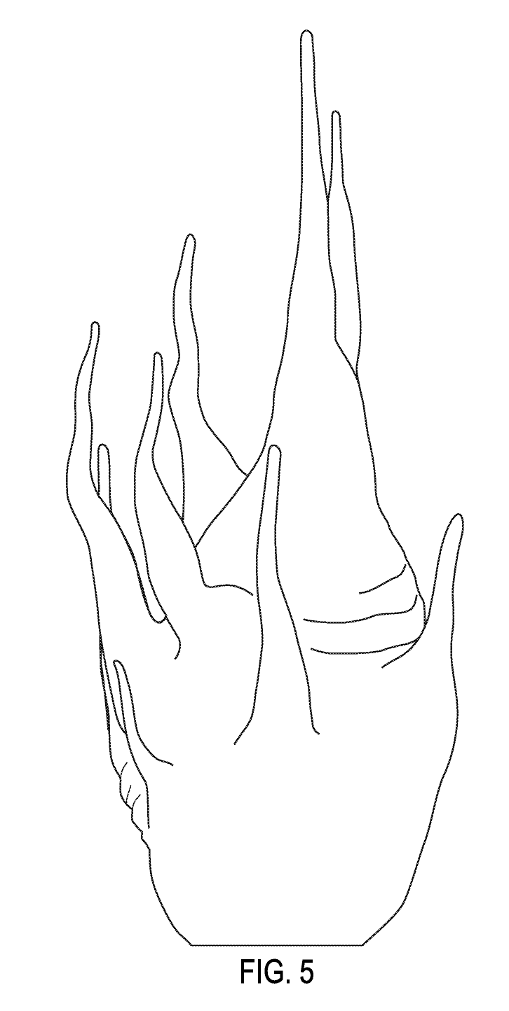

FIG. 6 is a top plan view thereof;

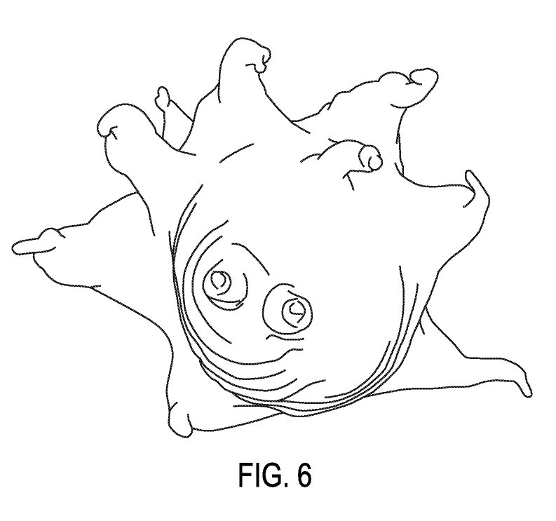

FIG. 7 is a bottom plan view thereof;

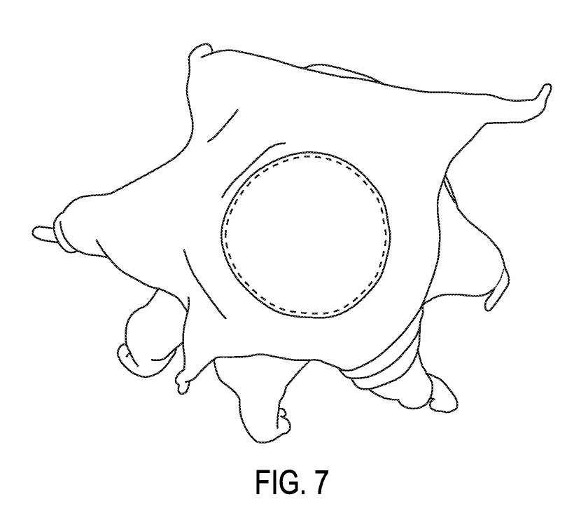

FIG. 8 is an example of an embodiment of an overlay shown together with a lightbulb with the lightbulb's tip directed towards an open end of the overlay.

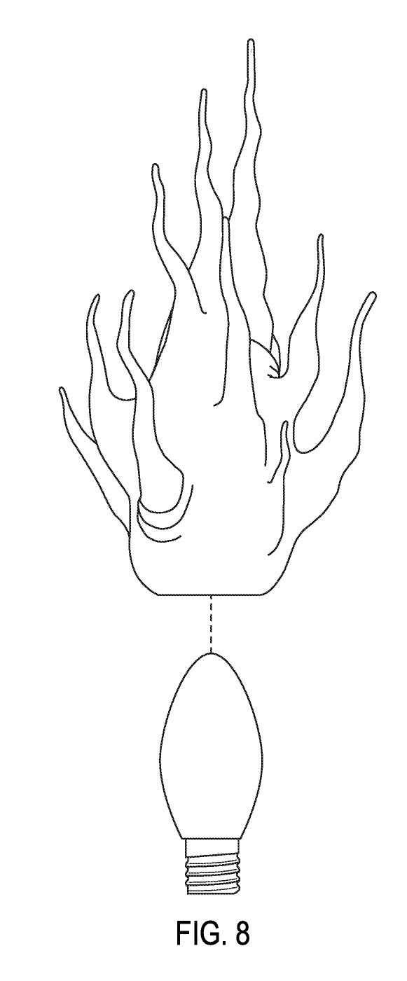

FIG. 9 is an example of an embodiment of a lightbulb covered by an overlay with a base of the lightbulb showing through an open end of the overlay.

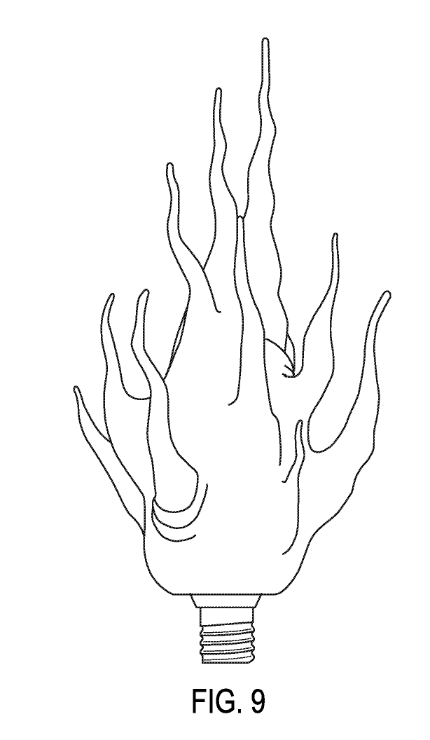

### DESCRIPTION OF EMBODIMENTS

The overlay of the present invention is a multi-flame tipped article and appears like a flame. The overlay may be placed over a light, a light bulb or any other light sources. By simply placing the article, the overlay will appear like a real flame.

When the overlay is placed over a light source, the light, the light bulb, or the light source may be of any size or wattages, so long as an overlay is able to cover at least part of the light, the light bulb, or the light source. The strength of the light may be of any strength and the source or sources may be of any origin, size or strength and may come from electricity, LED, natural light, or any other source capable of producing light, and the overlay is able to cover at least part of the source.

The overlay may or may not have an opening on the base end. The body section of the overlay may also be at least partially hollow and the exterior of the body extends away from the open end. The body of the overlay as it extends away from the open end has multiple tips that extend out of the body and extend away from the base end. More than one tip extends out of the body with no upper limit on the number of tips, and depending of the color and the amount of light that may pass through the material of the overlay, the overlay appears like a real flame when the light is turned on. The material may appear to glow, depending on the color, the material and the amount of light passing through the material. The end of the tips may be of any shape, such as straight, bent, bulbed, or curled. The surface area of the body, including the surface area of the body forming a tip, may be smooth, rippled or may have one or more ridges.

The overlay may be adhered or attached to a light, light source or a light bulb, either with or without an adhesive material. The overlay may also be simply placed over or slipped over a lightbulb or a light source. The body of the overlay that extends away from the base end may have a hollow space where a light bulb or light source may be placed. The hollow space may be completely filled with the light bulb or light source or some empty space may remain unfilled.

The overlay may be made of any material but elastic material is preferred when the overlay is to be placed over or slipped over a lightbulb or a light source. The elastic material, for example may be, silicone, rubber, soft plastic, and other elastic heat resistant material. Out of the known elastic material, silicone is one of the preferable materials due to its elasticity and high heat resistance. The elasticity of the silicone material may allow the overlay to elongate or stretch up to 600% of its un-stretched length. The silicone material may also resist heat of up to 1700° F.

The overlay may be in any color. Depending on the color and the type of material used to make the overlay, no light may pass through the overlay or some or most of the light from the light source may pass through the material. The overlay that passes at least some light may glow in different colors when the light is turned on with the overlay covering the light.

When the light is provided with a control, such as a dimmer, to adjust the intensity and/or the strength of the light, the overlay may glow and appear in different colors, ranging from white to yellow to orange.

1. An overlay for a light source comprising:
a body with a base end and at least more than one tip extending away from the base end, wherein the body is made of elastic material and includes a hollow space, an opening to the hollow space on the base end of the body, multiple tips of varying length extending away from the base end.

2. (canceled)

3. (canceled)

4. (canceled)

5. The overlay according to claim 1, wherein the elastic material is a silicone.
